(19) United States
(12) Patent Application Publication
(10) Pub. No.: US 2012/0196253 A1
(43) Pub. Date: Aug. 2, 2012

(54) INTERACTIVE COMMUNICATION DESIGN SYSTEM

(75) Inventor: Audra Duvall, Las Vegas, NV (US)

(73) Assignee: Audra Duvall, Las Vegas, NV (US)

(21) Appl. No.: 13/362,864

(22) Filed: Jan. 31, 2012

Related U.S. Application Data
(60) Provisional application No. 61/438,085, filed on Jan. 31, 2011.

(51) Int. Cl. G09B 19/00

(52) U.S. Cl. 434/156

(57) ABSTRACT

Embodiments of techniques and systems for utilize an interactive communication design system (“ICD”) along with a prompt-and-response mode of collecting data for the purposes of organizing ideas to be included in an essay are described. In various implementations, a series of pre-formulated essay questions, or prompts, may be posed to a student individually so as not to overwhelm him or her and to encourage and secure participation. The prompts may incorporate responses to previous prompts and may encourage restatement of ideas from the student. Responses that are received may be saved and published in various professional formats. Additionally, the generated work may be analyzed and one or more metrics generated based on the work. Other embodiments may be described and claimed.

### CROSS-REFERENCE TO RELATED APPLICATIONS

This application claims the benefit of U.S. Provisional Application No. 61/438,085, filed Jan. 31, 2011, and titled “Interactive Communication Design System.” The application is hereby incorporated by reference in its entirety.

### TECHNICAL FIELD

Embodiments of the present invention relate to electronic facilitation of written communication, and in particular to providing measured interactive assistance for generation of written communication, such as, for example, essays.

### BACKGROUND

Existing pedagogical techniques and technologies which seek to aid students in the writing of essays suffer from various weaknesses, and in particular show weakness with the teaching of essay writing with respect to visual learners; these visual learners may comprise between 65%-75% of some learning communities. Students who are not properly supported by existing techniques will continually fail to master, or to even understand at a basic level, the process of essay crafting. As this continues from year to year, these students face a growing abyss between their skills and the foundational and holistic communication skills needed for success in the modern world.

Moreover, instructors are oftentimes required, for example due to legal mandates, to teach essay skills in every class, and to every student, no matter the content. These instructors, however, will not necessarily all possess the same set of skills in the arena of essay structures and pedagogy. This variance between instructors increases the likelihood of subjectivity and confusion on an already vacillating and organic topic. Additionally, those instructors that are highly skilled in the arena of essay structures may become overwhelmed with the amount of work involved in teaching varying abilities and levels of essay writing within a class and with repeating basic steps as the steps are misunderstood or ignored by students. Existing tools fail to teach students foundational steps to writing essays while simultaneously catering specifically to the needs of visual learners. This failure endangers these learners' ability to understand the process and has the side effect of limiting their writing experiences.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIG. 1 is a block diagram illustrating relationships between entities in an interactive communication design system in accordance with various embodiments.

FIG. 2 is a block diagram illustrating modules and stored information in an interactive communication design system in accordance with various embodiments.

FIG. 3 is a flowchart illustrating an exemplary process for preparing written communication using the interactive communication design system in accordance with various embodiments.

FIG. 4 is a flowchart illustrating an example process for prompting a student and receiving written responses to prompts in accordance with various embodiments.

FIG. 5 is a flowchart illustrating an example process for verifying and presenting an essay to a student in accordance with various embodiments.

FIG. 6 is an example screen illustrating interactive activity using the interactive communication design system in accordance with various embodiments.

FIG. 7 is a further example screen illustrating interactive activity using the interactive communication design system in accordance with various embodiments.

FIG. 8 is a further example screen illustrating interactive activity using the interactive communication design system in accordance with various embodiments.

FIG. 9 is a further example screen illustrating interactive activity using the interactive communication design system in accordance with various embodiments.

FIG. 10 is a further example screen illustrating interactive activity using the interactive communication design system in accordance with various embodiments.

FIG. 11 is a further example screen illustrating interactive activity using the interactive communication design system in accordance with various embodiments.

FIG. 12 is a further example screen illustrating interactive activity using the interactive communication design system in accordance with various embodiments.

FIG. 13 is a further example screen illustrating interactive activity using the interactive communication design system in accordance with various embodiments.

FIG. 14 is a further example screen illustrating interactive activity using the interactive communication design system in accordance with various embodiments.

FIG. 15 is a further example screen illustrating interactive activity using the interactive communication design system in accordance with various embodiments.

FIG. 16 is a further example screen illustrating interactive activity using the interactive communication design system in accordance with various embodiments.

FIG. 17 is a further example screen illustrating interactive activity using the interactive communication design system in accordance with various embodiments.

FIG. 18 is a further example screen illustrating interactive activity using the interactive communication design system in accordance with various embodiments.

FIG. 19 is a further example screen illustrating interactive activity using the interactive communication design system in accordance with various embodiments.

FIG. 20 is a further example screen illustrating interactive activity using the interactive communication design system in accordance with various embodiments.

FIG. 21 is a further example screen illustrating interactive activity using the interactive communication design system in accordance with various embodiments.

FIG. 22 is a further example screen illustrating interactive activity using the interactive communication design system in accordance with various embodiments.

FIG. 23 is a further example screen illustrating interactive activity using the interactive communication design system in accordance with various embodiments.

FIG. 24 is a further example screen illustrating interactive activity using the interactive communication design system in accordance with various embodiments.

FIG. 25 is a block diagram illustrating a generalized example of a computing environment on which several of the described embodiments may be implemented.

### DETAILED DESCRIPTION OF EMBODIMENTS

In the following detailed description, reference is made to the accompanying drawings which form a part hereof, and in which are shown by way of illustration embodiments in which the disclosure may be practiced. It is to be understood that other embodiments may be utilized and structural or logical changes may be made without departing from the scope of the present disclosure. Therefore, the following detailed description is not to be taken in a limiting sense, and the scopes of embodiments, in accordance with the present disclosure, are defined by the appended claims and their equivalents. Likewise, illustrated implementation details are not intended to demonstrate any particular requirements or limitations of embodiments described herein, but are instead offered merely as examples of the described embodiments.

Various operations may be described as multiple discrete operations in turn, in a manner that may be helpful in understanding embodiments of the present invention; however, the order of description should not be construed to imply that these operations are order dependent.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C).

The description may use the phrases “in an embodiment,” or “in embodiments,” which may each refer to one or more of the same or different embodiments. The description may also use the phrases “in an implementation,” or “in an alternative implementation,” which may each refer to one or more of the same or different implementation details of various embodiments described herein. Furthermore, the terms “comprising,” “including,” “having,” and the like, as used with respect to embodiments or implementations, are synonymous. The term “exemplary” is used herein merely illustrates that an example is being shown or described and is not intended to denote that any so-described feature is preferred, required, or necessarily presents particular advantages over any other. While flowcharts and descriptions of processes may make reference to particular steps or actions, it should be understood that, in alternative implementations, the illustrated steps may be combined or divided into two or more sub-steps. Also, while block diagrams may illustrate particular entities, blocks, or modules, it should be understood that, in alternative implementations, the illustrated entities, blocks, or modules may be combined, divided, or removed, and that additional entities, blocks, or modules may be utilized.

Implementations are described herein with reference to an “essay” or a “speech.” While this language is used as an example of particular types of written and/or oral communication, various implementations described herein may be utilized with other forms of communication, and the usage of the “essay” and “speech” terminology is not intended to suggest that the following techniques are limited solely to particular types of communication. Additionally, while particular interface implementations are described and illustrated herein, they are not meant to imply any particular requirements or limitations on the interfaces which may be used. Instead, they are included as examples which illustrate particular implementations of the techniques and systems discussed herein.

Embodiments described herein relate to an interactive communication design system and teaching method that invites a participant to answer organizationally-specific essay questions that are appealing to the visual learner. Use of the system helps prevent the participant from experiencing writer's block and helps increase the participant's motivation. By providing motivation and inertia for the writer, the system may increase use, practice, and individual students' success rates at developing writing and communication skills. Additionally, by employing a means of scaffolding and pattern-recognition, once the method is understood through use of the system, a student may be more free, willing, and able to learn independently of the system.

In various embodiments, the system provides methods of teaching in which the student's responses to questions relating to the educational information may be used to develop a database of accumulated responses—for example, the database may contain a student's written work, objective scores, as well as provided feedback. The system additionally comprises the ability to publish a student's work in various formats, such as, for example, hard copies, visual aids, speech outlines, peer-editing sheets, teacher grading rubrics. These publishing options may also be edited according to intentions of a student or an instructor, such as for grammar, conventions, voice, ideas, or grades.

Embodiments are also directed toward providing interactions for students which mimic aspects of computer and video games that the students consider to be “fun” with instructional capabilities of teaching essays, speeches, and basic communication skills. In various embodiments, the system and methods may incorporate scoring for formulaic responses; this scoring capability makes feedback aspects automatic and reduces or eliminates subjectivity in scoring. As such, this may allow students to understand various minutia of learning essay structure and writing without slowing an instructors overall teaching process by placing all demands on the instructor. In other embodiments, the system may include the ability to invoke other written forms of communication within the realms of contemporary and familiar modes of highly-motivated expression, while simultaneously allowing for safe and regulated outside analysis. Such forms may include blogs, polls, and other forms of commentary and publishing capabilities directly related to inspired, creative, and motivationally-based work.

Various embodiments comprise teaching methods and computer teaching systems. In overview, the teaching methods utilize an interactive communication design system (“ICD”) along with a prompt-and-response mode of collecting data for the purposes of organizing ideas to be included in an essay. Much like a short-survey, aspects of the ICD may allow for a series of pre-formulated essay questions to be posed to a student individually so as not to overwhelm him or her and to encourage and secure participation. In various embodiments, the ICD may be adaptable to cater to various arenas of learning communication, such as primary, secondary, post-secondary. Additionally, various embodiments may include adaptations focused on particular career demands for highly skilled communicators.

The ICD may utilize both teaching methods and computer teaching systems in that embodiments work systemically by not only triggering responses from students but also by collecting work received, saving it, and publishing the work in professional formats (such as reports, formal essays, research, electronic visual presentations, and blog contributions) as well as objective or subjective grading formats, such as, respectively, computer rubrics and teacher/peer rubrics.

In various embodiments, instructors using the system may be able to choose from a variety of default settings; in one example, an instructor may choose settings according to her state-mandated standard expectation for the writing of essays and formal presentation. In order to adjust the settings to match specific needs of the school and classroom, in various embodiments instructors may choose to adjust grading scales as well as rubric requirements; these changes may be later attributed to a published expectation of the student's writing.

In various embodiments, students using the ICD may be able to securely sign on using an identity code; in one implementation, the code may be given to them by their school or instructor. The student may, in various embodiments, be allowed to fill out a personalized page that includes personal information, such as, the student's picture, age, instructor, favorites lists, background design, font choice, music, and other details that are user-friendly, welcoming, inspiring and/or empower ownership capabilities in the student.

Once the student has entered the ICD, he or she may participate in various starting tasks, such as class blogs, polls, or previously-presented creative writing opportunities before beginning a current writing task; the starting tasks may be provided in order to spark the student's creativity and motivation. The ICD may then offer the student a chance to choose the task he or she is to complete, to decide upon his or her level of personal expertise in the area, and then to begin the process of answering the questions pertaining to his or her choice.

In one embodiment, a feature of the ICD may comprise structuring prompts which are given to a student such that they are visually colorful and enticing. In another embodiment, the prompts may also be structured to be clear of visual distractions, such as by leaving a small white note-size response section for the student to interact with; this can encourage brief and clear submissions from students. In one embodiment, once responses are entered, at various points a student may be offered the ability to save his or her work, edit previous entries, review his or her work, publish the work, or exit the program. In one embodiment, when the student has finished a series of questions needed to create a basic essay, he or she may be encouraged to see his or her work thus far, seek a potential grade, and make changes according to the rubric or their own desire for a better grade.

In one embodiment, the ICD may accumulate responses given by a student for the purposes of receiving the data; analyze and format the response, such as according to basic essay standards, conventions, grammar, etc.; and prepare the work according to a predetermined order. In various implementations, the order used to prepare the work may be the order with which the work was transmitted or prompted for the purposes of submission. The work may be saved to a database, which can be, in various embodiments, accessed by the students, the instructors, and/or administration in order to guide the student's further education.

In various embodiments, methods may structure teaching around various forms of essay structures, such as persuasive, expository, and narrative; however, in various embodiments, additional categories and sub-categories may be utilized. The ICD may be, in various embodiments, designed to encourage writing while not regulating human expression. In this manner, it may depart from disciplinary norms of traditional schooling. For this reason, in some embodiments the ICD includes administrative options which allow certain “fire wall” items to be included or identified. By preventing use of these terms, individuals who may view the work are protected from expression which may be considered inappropriate by the educational community using the ICD.

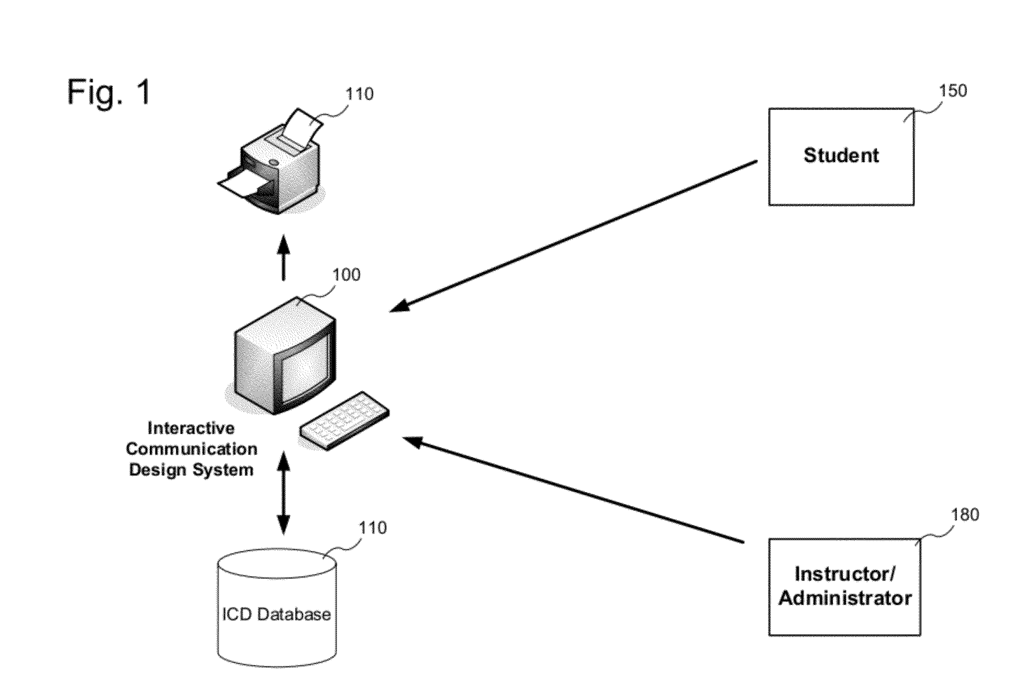

FIG. 1 is a block diagram illustrating entities used in embodiments of an ICD 100. As illustrated at FIG. 1, in various embodiments the ICD 100 may be implemented on a personal computer or other computing device, such as in the computing environment described above. Interactions with the ICD 100 are performed, according to various implementations, by both students 150 and instructors and/or administrators 180. As described herein, the instructors and/or administrators 180 may interact with the ICD 100 in order to set up the ICD 100 for use by students 150 to prepare and generate essays and/or speeches. The instructors and/or administrators 180 may also interact with the ICD 100 in order to set up the ICD 100 or to set preferences, such as firewall preferences, as described herein.

The student, by contrast, may interact with the ICD 100 in order to prepare and generate essays and/or speeches, to select personalization preferences according to the student's needs or desires (as possibly moderated by instructor settings), and to publish finalized versions of prepared essays and/or speeches. To aid in these interactions, the ICD 100 utilizes an ICD database 110, which stores information, as described below. The ICD 100 may also interact with one or more publishing devices, which are represented in FIG. 1 as a printer 105.

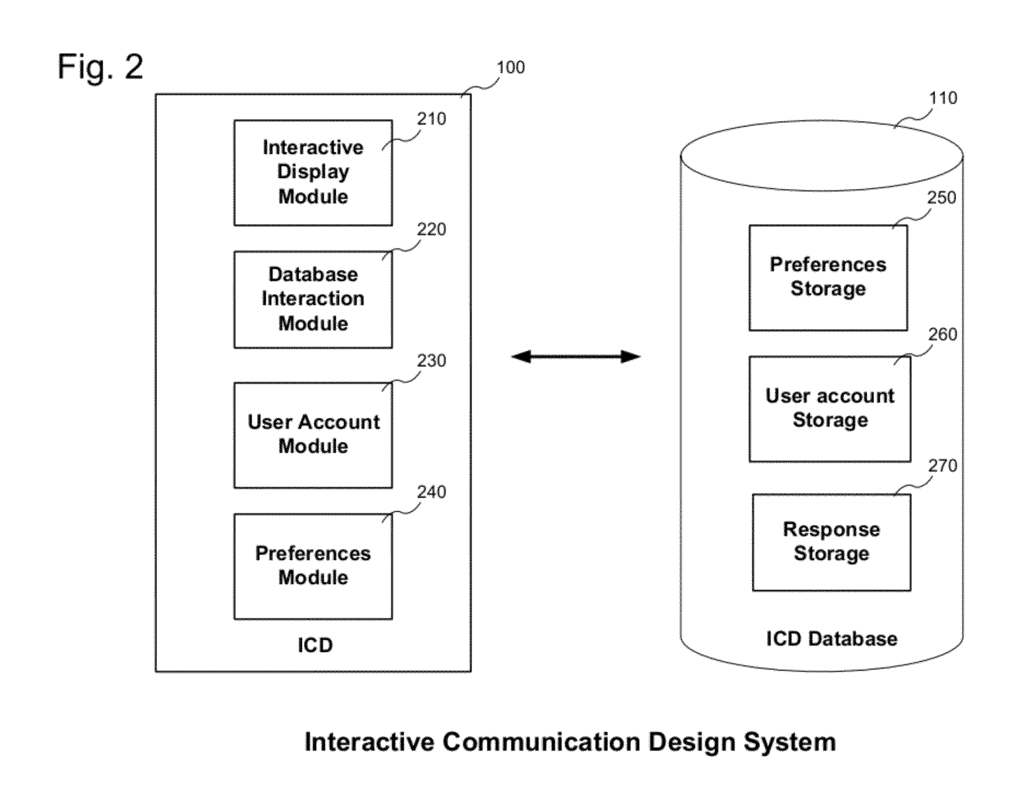

FIG. 2 is a block diagram illustrating various modules and stored information which are used by the ICD 100 to provide interactive communication design to students. As illustrated, the ICD 100 may contain an interactive display module 210. In various implementations, the interactive display module 210 may be used to show information to a student or instructor using the system. Such information may include, but is not limited to: prompts for student input, illustrations of previously-received responses; display of student personalization options and previously-input personalized information; and display of instructor options. In various implementations, and as described below, the interactive display module 210 may optionally display particular information in various colors or with different degrees of emphasis in order to call attention or draw attention away from particular information. The interactive display module 210 may also, in various implementations, provide for input of responses to various prompts, as well as limiting which information can and cannot be used when responding.

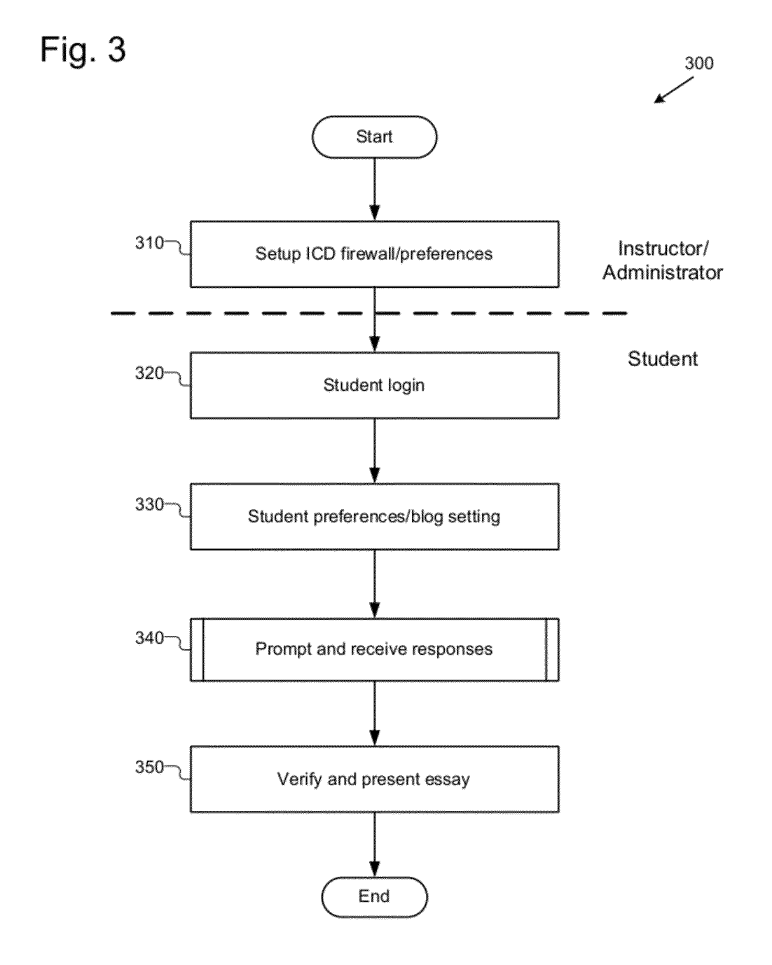

Next, FIG. 2 illustrates a database interaction module 220. In one implementation, the database interaction module 220 may store and retrieve information stored on the ICD database 110, and to keep the information in an organized and retrievable format. For example, and as illustrated in the information stores of the ICD database 110 also shown in FIG. 3, the database interaction module 220 may interact with the ICD database 110 to store and retrieve student and/or instructor preferences in preferences storage 250 of database 110. The database interaction module 220 may interact with the ICD database 110 to store and retrieve user account information, such as logins, passwords, and security privileges in user account storage 260 of database 110. The database interaction module 220 may interact with the ICD database 110 to store and retrieve responses from students to various prompts provided during use of the ICD 100 in response storage 270 of database 110. While particular information, such as responses to prompts, may be illustrated or published in a particular order, it should be noted that, in various implementations, the database interaction module 220 may store such information in a variety of formats, structures, and arrangements, and may not store a version of response information at all times which is identically-arranged to the eventually-published version. In various implementations, one or more of the preferences storage 250, user account storage 260, and/or response storage 270 may be maintained on separate databases or on other storage implementations.

Next, FIG. 2 illustrates a user account module 230 and a preferences module 240. The user account module 230 may be used to maintain user account information, such the user information discussed above, and to allow users to change their information. The preferences module 240 may be used to store particular preferences, including, in some implementations, student personalization information, and to provide those to the system during the use of the ICD 100.

FIG. 3 is a flowchart illustrating an exemplary process 300 for generating communication using the ICD 100. The illustrated process may be performed by various entities including an instructor (or administrator) and a student; the illustrated dotted line indicates actions which may be performed by various entities. The process may begin at operation 310, where firewall information and/or preferences for the ICD 100 may be set up by the instructor and/or administrator 180. Particular examples of these preferences and the use of the firewall are discussed herein. Next, at operation 320, a student 150 may login to the ICD 100. In various embodiments, this may be performed with reference to a user ID created for the student 150 by an instructor or administrator 180; in others, the student 150 may perform a registration process to begin.

Next, at operation 330, the student 150 may be provided an opportunity to set preferences, or participate in blog entry activities. At operation 330 in various implementations, the student 150 may be allowed to perform various personalized interactions interaction outside of an essay-drafting process, such as providing personal information. In various implementations, this personal information may comprise responses to prompts about the student 150, such as, but not limited to, the student's likes and/or dislikes, goals, past events, and/or opinions, In various implementations, these personalized interactions may ease the student's entry into the process.

Next, at operation 330, the student 150 may be prompted by the ICD 100 and may provide responses based on the prompts give by the ICD 100. Particular examples of the prompts and responses are provided below.

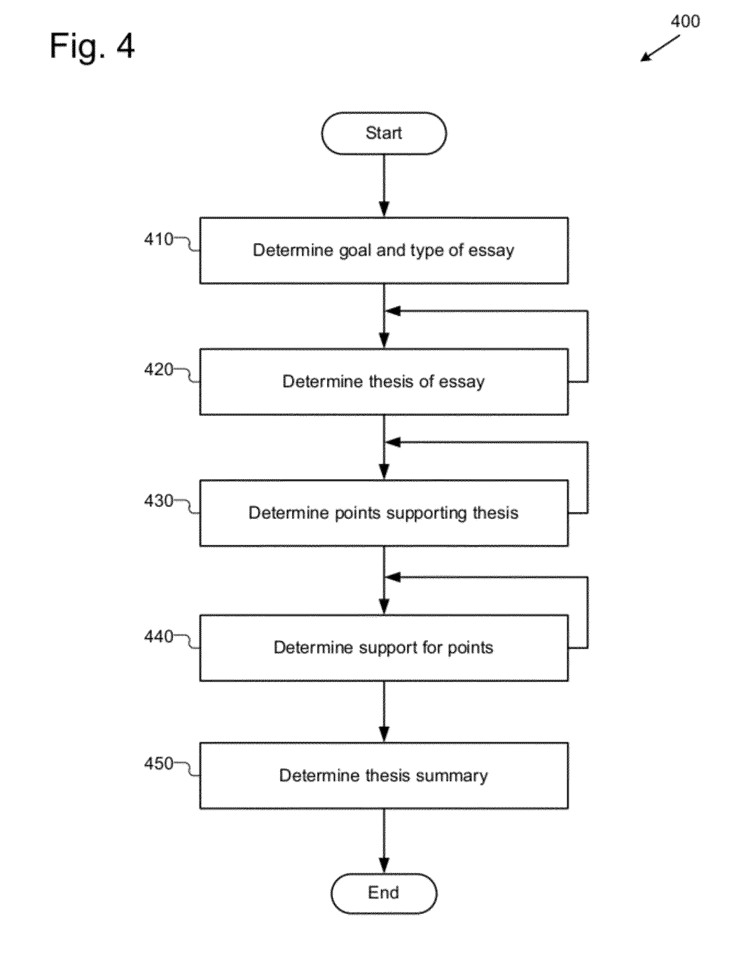

FIG. 4 is a flowchart illustrating an example process 400 for prompting a student and receiving written responses to prompts in accordance with various embodiments. Process 400 may represent one or more implementations of operation 340 of FIG. 3. In various implementations, the ICD 100 may repeat similar or identical styles of prompts, as described herein, and thus the process may repeat this step one or more times. In various implementations, the ICD 100 may provide multiple versions of prompts. For example, the ICD 100 may rotate through differently-worded prompts which are directed at eliciting similar information in order to avoid student fatigue at receiving the same-worded prompt each time the ICD 100 is used. In another implementation, the ICD 100 may provide an interactive element associated with a prompt which, when activated by a student, provides a differently-worded version of the original prompt, such as, for example, a simpler wording. The use of alternative vocabulary and structure for the prompts may aid in student understanding and response success.

The process may begin at operation 410, where the ICD 100 may receive, such as by prompting the student 150, the type and goal of the essay being written by the student 150. Next, at operation 420, the ICD 100 may receive a thesis for an essay. In various implementations, the ICD 100 may prompt one or more times to obtain multiple responses, allowing the ICD 100 to utilize multiple statements of the thesis by the student 150 when composing the essay. Next, at operation 430, the ICD 100 may receive points that support the thesis, such as by prompting for these points. In some implementations, the prompts may include restatements of one or more responses received when determining the thesis. In various implementations, the ICD 100 may prompt one or more times to obtain multiple points when composing the essay.

Next, at operation 440, the ICD 100 may receive support for one or more of the points received, such as by prompting for additional support. In some implementations, the prompts may include restatements of one or more responses received when determining the points. In various implementations, the ICD 100 may prompt one or more times to obtain multiple pieces of support when composing the essay. Finally, at operation 450, the ICD 100 may receive a summary of the thesis, such as by prompting for the summary. The process may then end. Particular examples of these prompts and types of responses that are elicited by the prompts may be discussed below.

Returning to FIG. 3, at operation 350, after the various prompt responses are received, the student 150 may be allowed to verify and present his or her essay, such as allowing the essay to be graded and/or printing a final copy of the essay. Particular implementations of the process of operation 350 are described below. The process may then end.

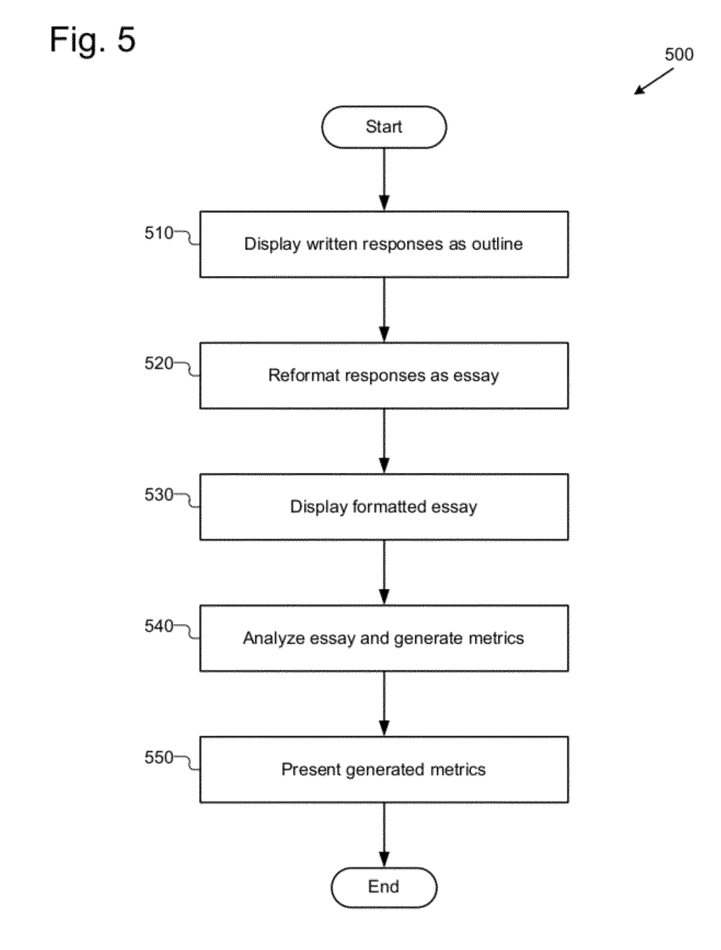

FIG. 5 is a flowchart illustrating an example process for verifying and presenting an essay to a student in accordance with various embodiments. Process 500 may represent one or more implementations of operation 350 of FIG. 3. The process may begin at operation 510, where the ICD 100 may display one or more written responses in an outline form. Next, at operation 520, the ICD 100 may reformat these responses in an essay form. Next, at operation 530, this reformatted essay may be presented to the student 150. Particular implementations of outline forms and reformatting may be described below. Next, at operation 530, this reformatted essay may be presented to the student 150. Next at operation 540, the ICD 100 may analyze the completed, reformatted essay to generate one or more metrics, such as described below. Finally, at operation 550, these metrics may be presented to the student 150. The process may then end.

In various implementations, the ICD 100 may interact with a single student 150 at a time. In this implementation, the student 150 may be allowed to customize the experience to his or her own preference as well as learn and work at his or her own pace. In alternative implementations, the ICD 100 may be configured to allow multiple students to interact with the ICD 100 and to draft essays at a single time.

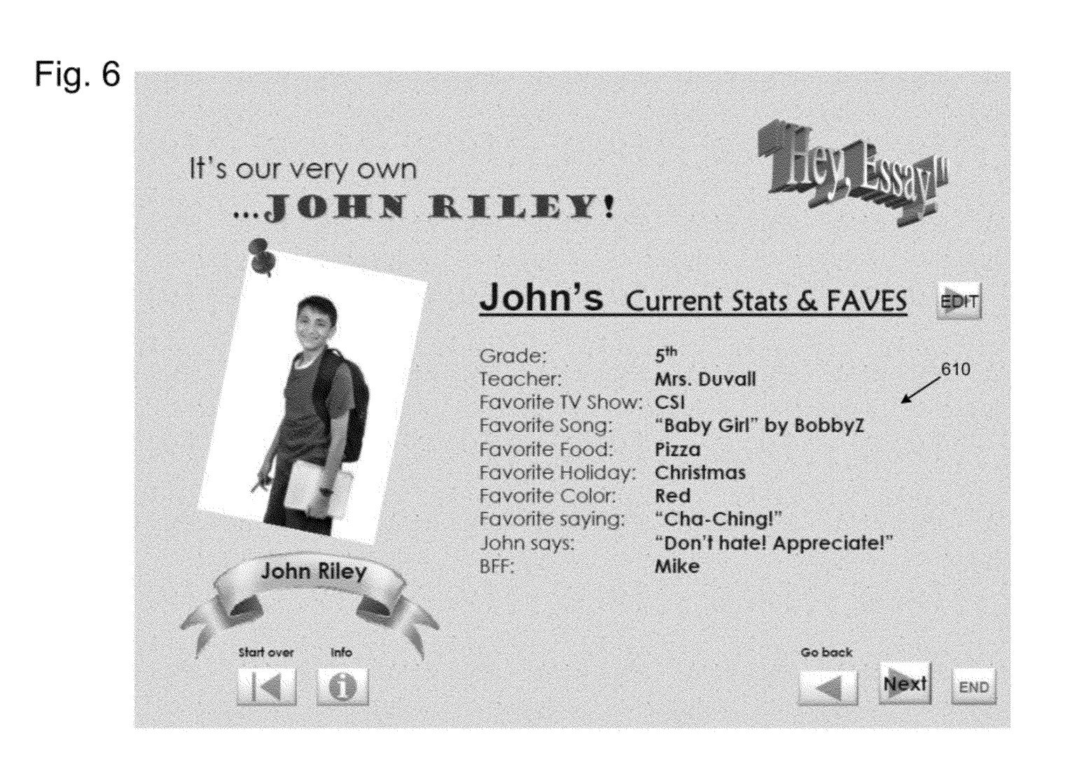

In various implementations, the process of using the ICD 100 may begin where the student is invited to log into the system. For example, an opening page (not illustrated) may illustrate the title of the ICD 100, such as “Hey, Essay!” and ask the participant to begin. This may, in various implementations, be accompanied by an illustration or animation which encourages the student to participate. For example, an illustrated door may announce “Knock, knock!” The ICD 100 may then illustrates the question, “Who is it?” and cue the student 150 to enter his/her login code to login. The student 150 may then enter his or her code. Entry of the code, in various embodiments, will trigger display of personal cues and entries saved, such as illustrated in element 610 of FIG. 6, as well as allowing for the future saving of personal preferences and cues.

Next, in various implementations the student 150 may be provided the opportunity to customize the ICD 100 to present a personalized interface during use; in various implementations, the saved preferences created during this process may be used during a current session and/or during future sessions. In one example of an initial setup, the student 150 may enter an initial personalization page. This page may be instructor created, in one implementation, such as according to a list of options, or may follow a default list of options. In one example, the personalization page may include the student 150's picture, age, instructor, favorites lists, background design, font choice, music choice, as well as other details, such as, for example, those illustrated at element 610 of FIG. 6. In one implementation, once these items have been loaded, items may remain unless any another educational community member, such as a student, parent, educator, or administrator, edits the entries. In various implementations, the choices offered to a student 150 may fall under privacy codes of a district or county jurisdiction in which the ICD 100 is being used. In one implantation, if the student 150 has previously filled in his or her personalization choices, the student 150 may be given the opportunity to re-enter his or her saved page of favorites with the option of editing before asked to continue.

In various implementations, and as illustrated in the various examples, ICD 100 prompts which elicit responses from students 150 may be structured so that the screen will be encouragingly colorful and clear of distractions. These screens may comprise a response area which is small and clear (such a small text-entry box) so as to appear limited in need and clear to begin. In various embodiments, this attribute of the ICD 100 may be useful in promoting sustained motivational momentum for the student. For example such a prompt is illustrated in the student's prompt to enter his “Favorite video game.”

In various implementations, the ICD 100 may include an administrative “firewall” to protect against abuse. In such implementations, certain word choices, such as those determined to be inappropriate usage in the relevant education community, will stop progress through the ICD 100 pedagogical procedures. The ICD 100 may then take various actions, such as triggering the opening title page, flagging the student for a pre-determined length of time, and/or submitting the student's entries to be reviewed by an instructor first in order to officially clear the post for publication, such as on a page provided to the instructor by the ICD 100. Also, in various implementations, the ICD 100 may be configured to set a time-limit for the areas of personalization and blog/poll participation before requiring the student 150 to proceed to communication program work.

In various implementations, implementation the ICD 100 may next ask the student 150 if he or she would like to cover a lesson in basics of communication. If the student 150 chooses ‘no’, the student may be directed past the lesson and on to drafting an essay. In one implementation, this option is provided for those students that have already used the ICD 100 previously and would like to expedite the procedure.

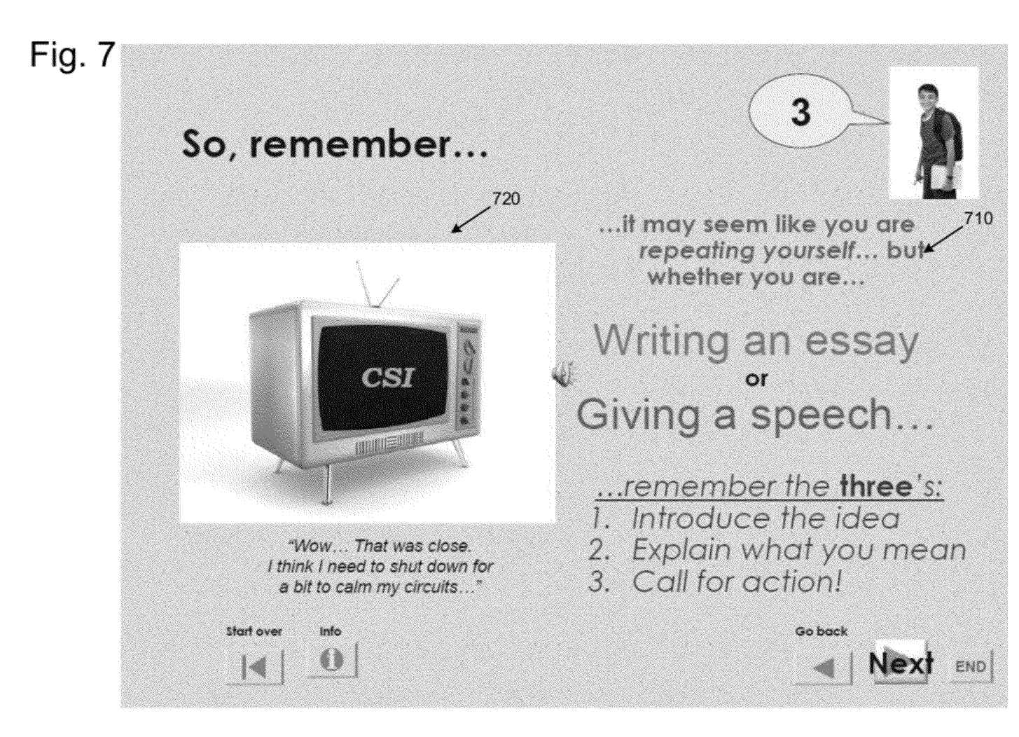

However, if a student 150 chooses ‘yes,’ in various implementations a lesson on communication may be triggered to provide an explanation, such as at element 710 of FIG. 7, of certain premises which underlie methods used in the ICD 100. Such premises may include, but are not limited to, simplicity, repetition, and observed commonality with respect to communication in real world. An example screen from such a lesson may be found at FIG. 7. As illustrated, in one implementation, the lesson may include a picture of the student 150 which may be used various pages of the lesson from the opening to the closing of the session. In another implementation, the lesson may also use accessing key items of the students favorites list, such as favorite saying, favorite show, favorite song, favorite radio station, etc., such as at element 720 of FIG. 7. The usage of these favorites is performed by the ICD 100 in order to personalize the message being conveyed.

Additionally, in various implementations, positively conditioned-statements may appear. In some implementations, these statements may be displayed in word balloons next to the student's picture. In other implementations, the statements may be displayed elsewhere, such as below a particular illustration or lesson. In various implementations, the positively-conditioned statements may be used to engage the student 150 with an imagined dialogue between the lesson being learned and the student 150. In one implementation, an example of which is illustrated in element 710 of FIG. 7, the lesson will specifically introduce the commonality of the repetition of threes in advertising, songs, and in personal communication with respect to a given example of basic communication that is successful or unsuccessful based upon simplicity, repetition, and observed commonality.

When the communication lesson is concluded, in various implementations, the student 150 may be presented with a list of questions or options to perform a general overview of what the student has accomplished in the primary and secondary mode. For example, in some implementations, the student 150 may be asked to explore topics such narrative, expository, persuasive, and research elements of writing. In one implementation, this overview/review may be based on educational requirements such as those provided by the No Child Left Behind Act. Additionally, the ICD 100 may provide displays, at the beginning and/or the end of the lesson, which show how much time and/or effort has been spent in one or more areas being reviewed. Students 150 that meet basic requirements, such as by achieving with a certain grade level, may then be provided with new opportunities for generating creative work. For example, a student 150 may be provided with a window where he or she can draft poetry, song lyrics, or other genres of writing with figurative language that may encourage the student 150. In one implementation, this added outlet for student creativity asks similarly to unlockable content in a video game, such as when a car racing game provides a new red sports car to a player that has achieved a predetermined goal.

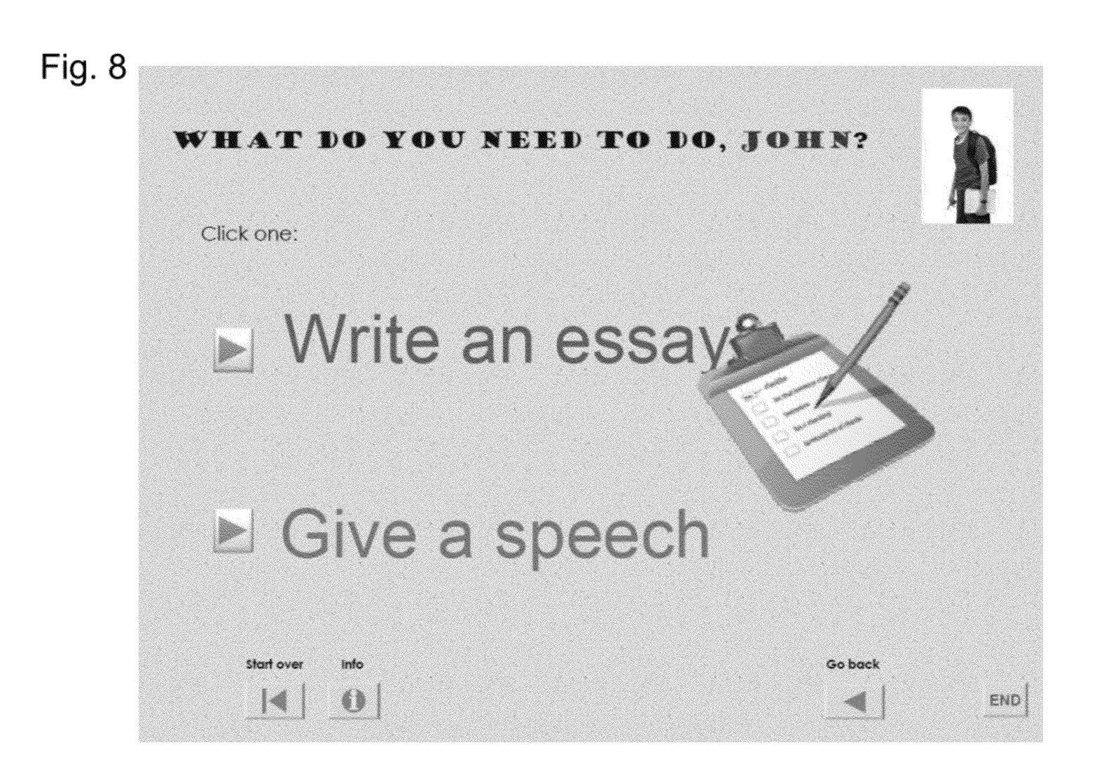

Regardless of the choice of the student, once the communication lesson has concluded, or if the lesson was intentionally skipped, the ICD 100 may prompt the student 150 with choices to create a new essay or speech, such as illustrated in FIG. 8. The student 150 may also be prompted to return to previous saved work. In various implementations, the student 150 not be allowed to return to blogs or polls; the ICD 100 may rely on settings to determine how often the student 150 is allowed to access portions of the ICD 100 unrelated to only essay or speech work. If the student 150 chooses previous work they may be directed to a portion of the ICD 100 that has saved their work and the ICD 100 may allow them to edit as well as go on to further lessons and questions in the realm of essay/presentation formatting and publishing capabilities.

In one implementation, if the student 150 chooses new work, the student 150 may be offered choices of whether to begin work on an essay or a speech. In various implementations, regardless of the student's choice, the student 150 may be provided with similar options for types (e.g., narrative, expository, persuasive) and be provided the same process for drafting. However, the outcomes may be different in the form of published material, such as production of a hard-copy essay format versus an outline presentation format. Additionally, lessons provided by the ICD 100 during the course of use may differ between essays and speeches as well. For example, lessons with respect to essays may pertain largely to conventions, spelling, grammar, and formality, while lessons in the area of speeches may pertain to visual aid conventions, spelling, and grammar with an emphasis on recording the collected and organized responses for memorization, or offering tips on best speech practices.

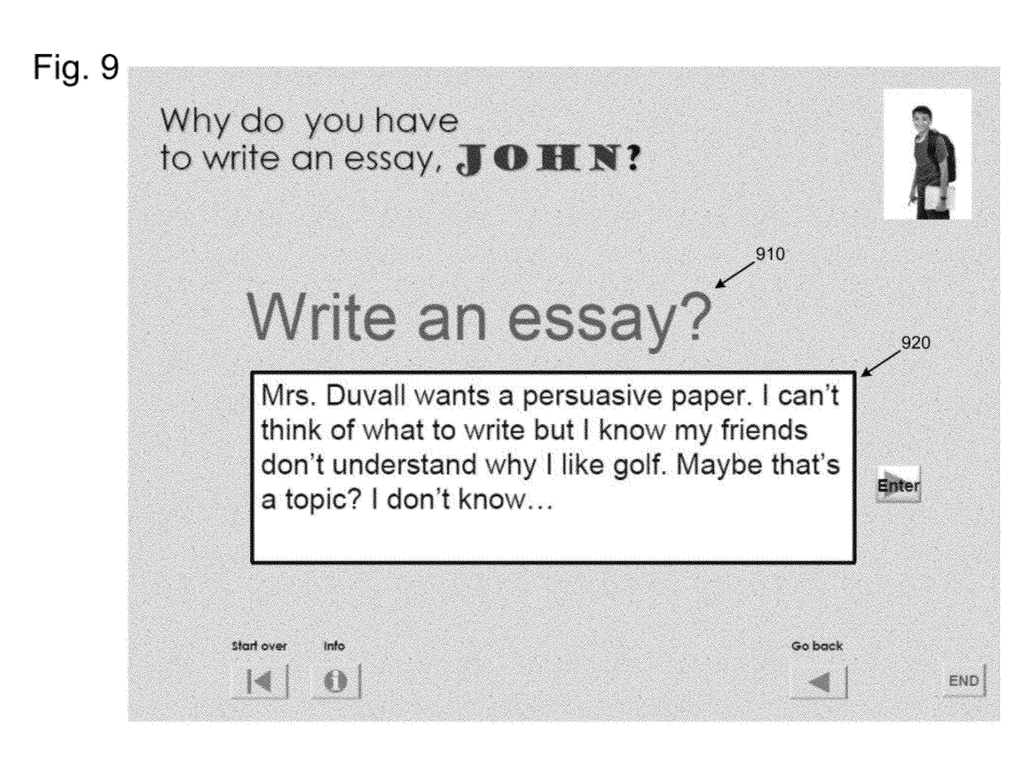

In one implementation, the ICD 100 may proceed to ask the question, “Why do you have to (give a speech/write an essay)?”. This may be performed in various implementations regardless of whether a speech or essay has been chosen. The question may also be asked, according to various implementations, in order to make the student aware of the primary objective of writing the essay or speech. An example prompt 910 and response form 920 can be found at FIG. 9.

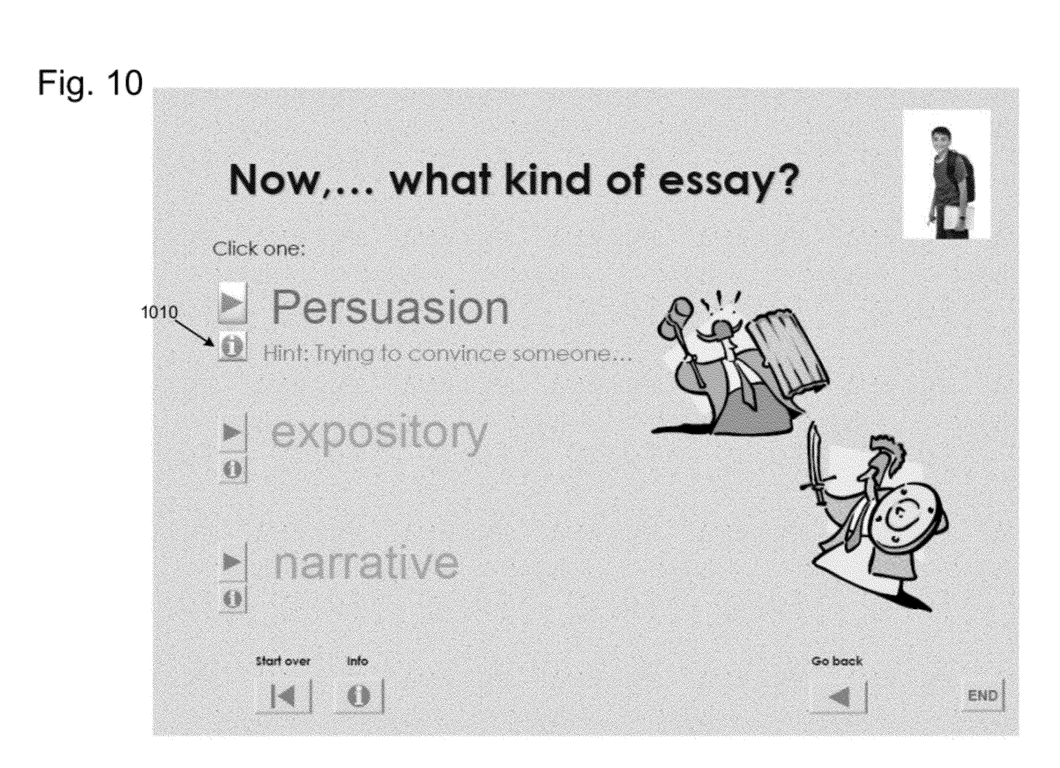

Next, the ICD 100 may ask the student which type of communication he or she is supposed to deliver, such persuasion, expository, narrative. In one implementation, the ICD 100 may also include “hint” buttons, such as element 1010, under the types which, when accessed, provide definitions or examples of the offered types. Then, once the type of essay or speech is chosen, the ICD 100 may secure certainty in this choice by the student and then continue to the next objective. Examples of this prompt and interaction with the hints and confirmation request may be seen at FIG. 10.

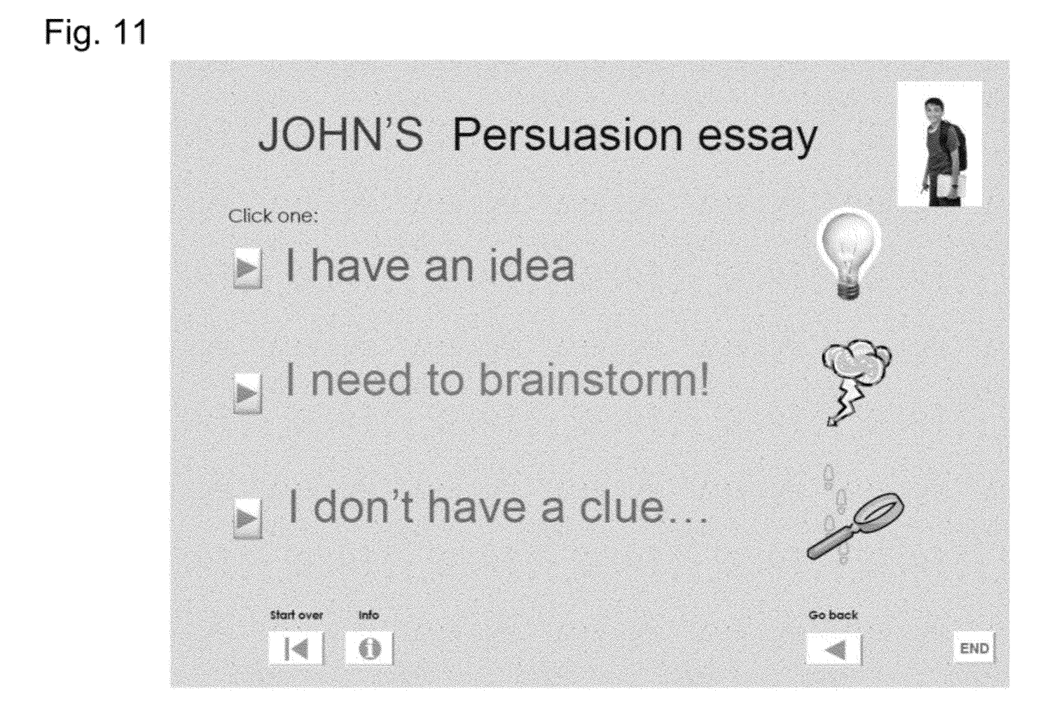

Next, in the example illustrated at FIG. 11, the ICD 100 may prompt the student 150 to “Choose one [of the following options]: “I have an idea,” “I need to brainstorm”, or “I don't have a clue.” The first option may be used when the student 150 is prepared and is aware of what is expected and feels he or she needs little assistance with the type or choice of work selected to begin. The second options may be used, for example, when the student 150 would like to work through some ideas, either with prompting or without.

The third option may be used, for example, when the student 150 needs assistance in the form of basic lessons that guide choosing how to proceed to produce successful work, such as by using real examples of outcomes and processes of the other two options. In various implementations, the examples of outcomes and processes in “I don't have a clue” will not be sentence examples but rather short stories cuing the student 150 to understand what is expected and how to proceed. In one implementation, the only choice that will lead the student to directly begin the writing process is the ‘I have an idea’ option. As before, after a choice is made, the ICD 100 will acknowledge the choice of the student and proceed.

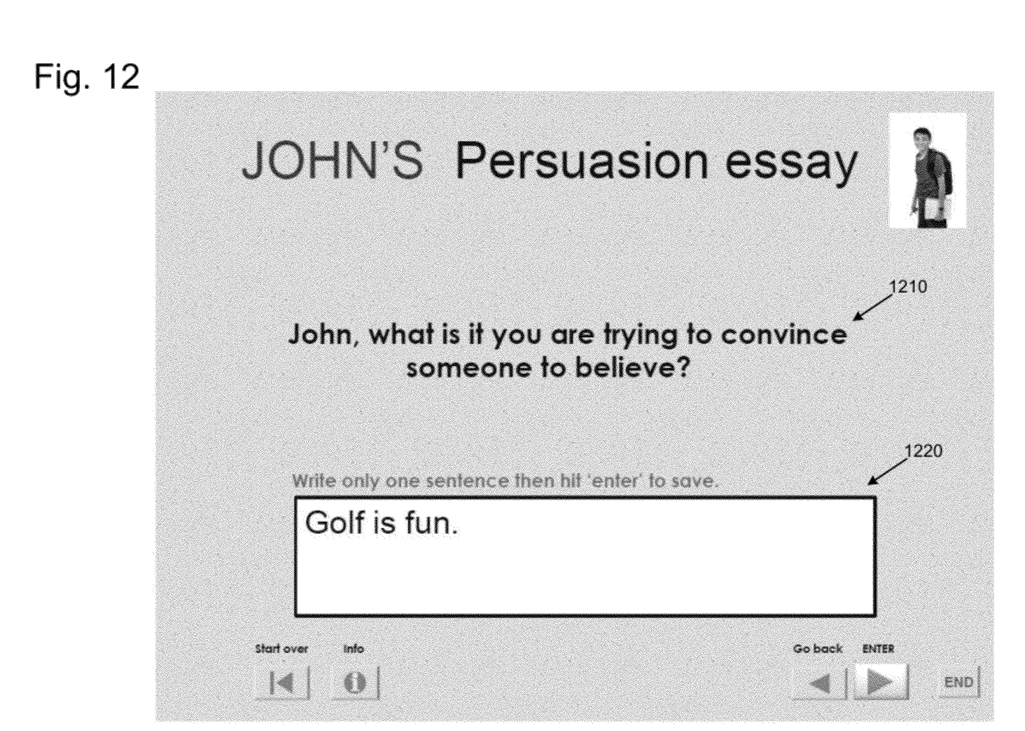

As illustrated in the implementation of FIG. 12, after the ICD 100 may then note the previously chosen communication category (e.g., persuasive, expository, or narrative) and may proceed to prompt the student to give an overarching statement of the primary purpose of his or her assignment. In various implementations, this prompt may be structured similarly to that of the “Why do you have to (give a speech/write an essay)?” prompt discussed above, but more conditioned to the specific main topic concept in order to trigger a potential thesis from the student. For the purposes of compact description, the remaining examples are geared to a persuasive model. It will be recognized that alternative implementations and choices by a student or participant will nonetheless utilize various embodiments and implementations described herein.

Thus, as illustrated in FIG. 12, the ICD 100 may prompt the student 150 with element 1210, which states “[Name of the student], what is it you are trying to convince someone to believe?” As illustrated, the prompt asks the student 150 to only write one sentence. The student 150 may then respond (such as in response form 1220) with a statement that represents his or her thesis. Next, the ICD 100 may take this response and save it, such as in a specific location in a database, as a thesis statement. In one implementation, the thesis statement will be maintained to be the last sentence of an introduction paragraph in a finalized essay. Next, to move onward, the student will choose ‘enter’.

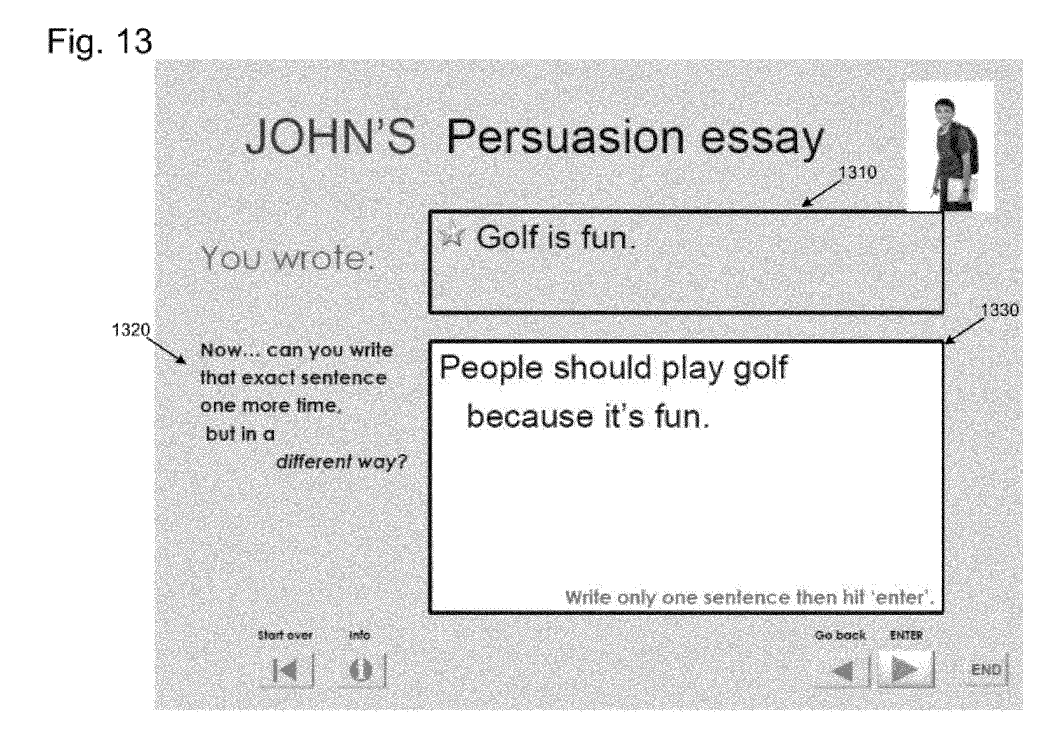

As illustrated in FIG. 13, the following screen presented by the ICD 100 may show the student's entered thesis statement in order to remind the student of his or her primary objective. Next, the student is prompted, such as by a prompt (at element 1310) reading: “You wrote: [Thesis statement]. Now . . . can you write that exact same sentence one more time but in a different way?” Once again, in one implementation, instruction is given for the student to only write one sentence (at element 1320). Students 150 that have taken the communication lesson described earlier may notice that this prompt is a first trigger to repeat. The student 150 may then allowed to respond (at element 1330) with a statement that represents the thesis, hopefully in a reworded fashion. The ICD 100 may then take the response and save it in the database in a location as the reworded thesis. In one implementation, the reworded thesis will be maintained to be the first sentence of the concluding paragraph in a finalized essay. Next, to move onward, the student will choose ‘enter’. For the purposes of compact description, it may be assumed going forward that, when illustrated, a student may choose ‘enter’ in order to proceed.

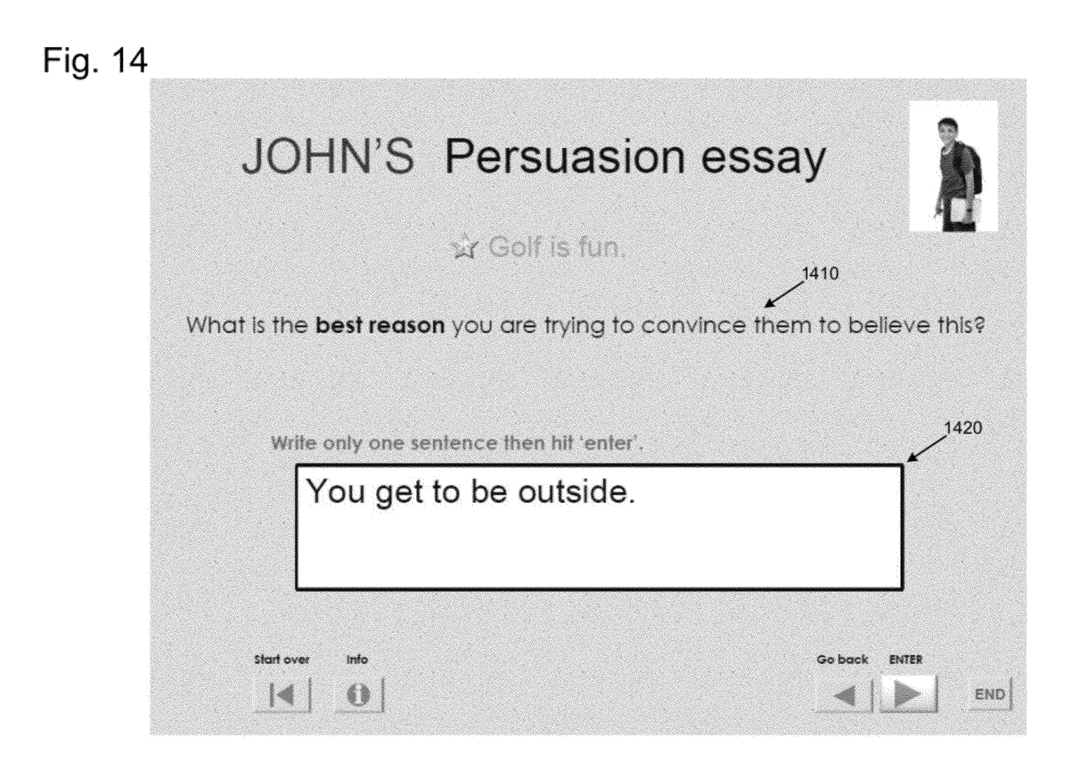

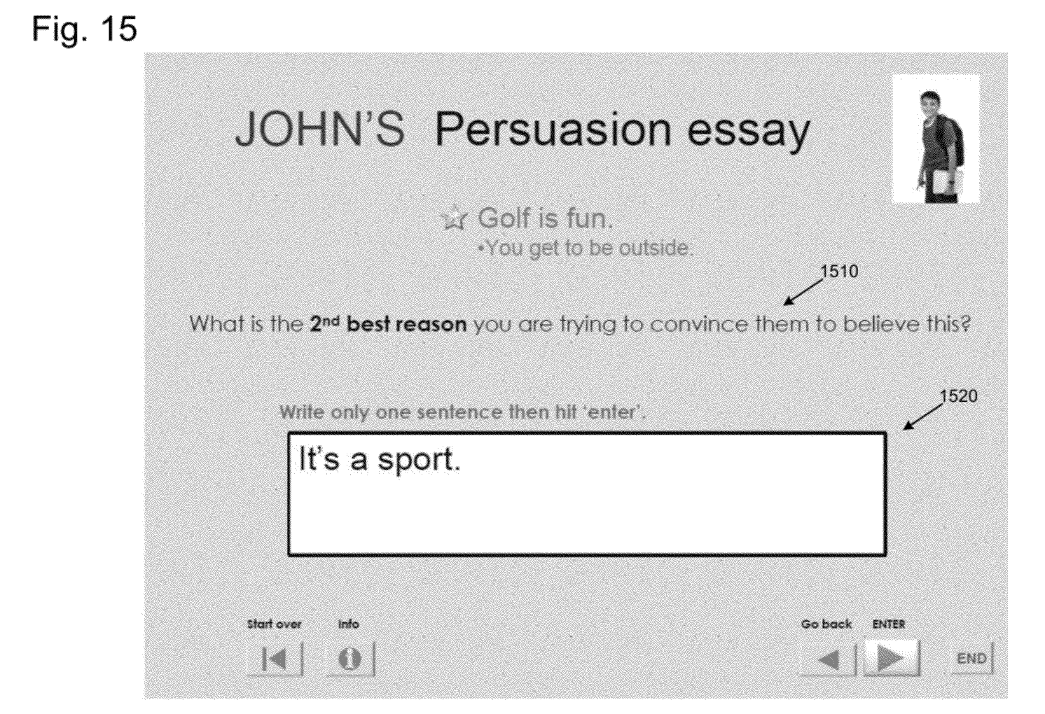

Next, the ICD 100 may proceed to illustrate the thesis statement in an emphasized manner in order to both remind the student 150 of the primary objective. However, the ICD 100, in various implementations, may not illustrate the reworded thesis statement. Next, the ICD 100 may provide a prompt asking for a rationale, such as: “What is the best reason you are trying to convince them to believe this?” at element 1410 of FIG. 14. Once again, as in implementations described above, instruction is given for the student 150 to only write one sentence. The student 150 may respond with a statement that represents the first reason statement. The ICD 100 may then take the response and save it in the database in a location as a first reason statement, such as in the response form of element 1420 of FIG. 14. In one implementation, the reworded thesis will be maintained to be the first sentence of the first main body paragraph. In various implementations, the ICD 100 may then repeat this process with the second and third (or up to n) reasons, prompting and saving the responses similarly to the process performed with respect to the first reason statement. Examples of these prompts and responses are illustrated at elements 1410, 1420, 1510, and 1520, in FIGS. 14 and 15, respectively.

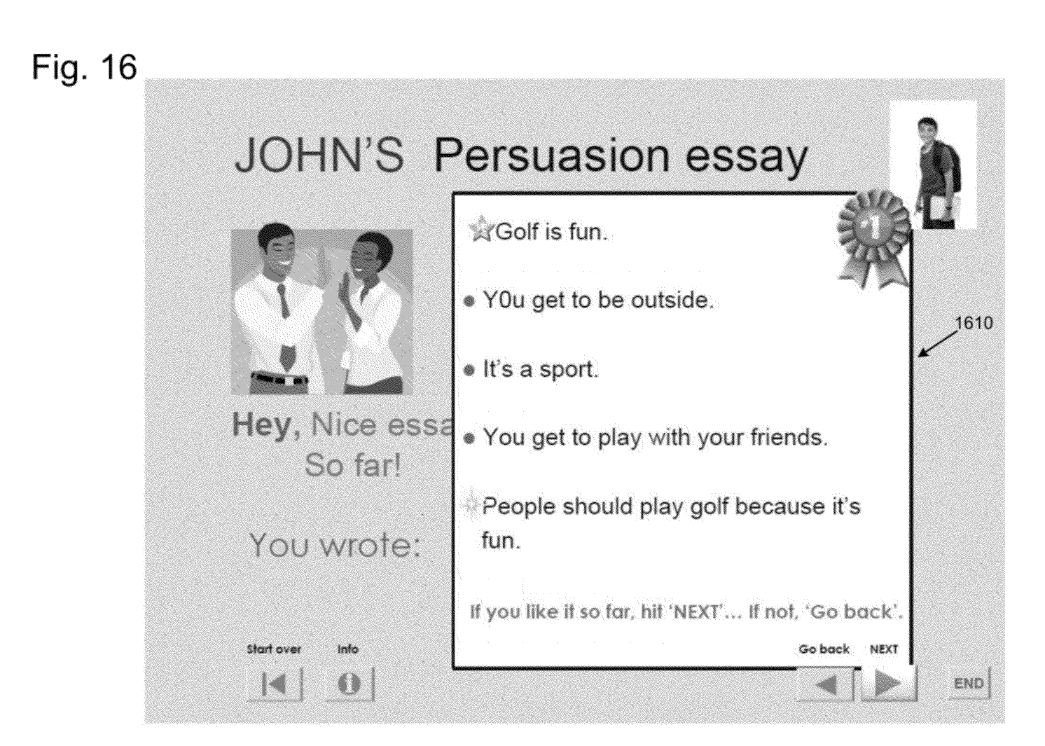

Next, the ICD 100 may provide the student with an illustration of the cumulative work thus far, such as in element 1610 of the illustrated example of FIG. 16. In one implementation, the work may be displayed according to the order in the essay it was maintained to appear in. In one implementation, the cumulative work screen is used to show the work completed at this point, which encourages and motivates the student 150 to continue, as well as see the speed and direction that his or her ideas are flowing. Much like showing the thesis statement with the supporting reasons in a lighter font, as in the preceding examples, this illustration of the work provides scaffolding and pattern-recognition for the student's through processes. The ICD 100 may also provide the student 150 with the option of either moving onward or returning to the previous pages to edit or save their work for later.

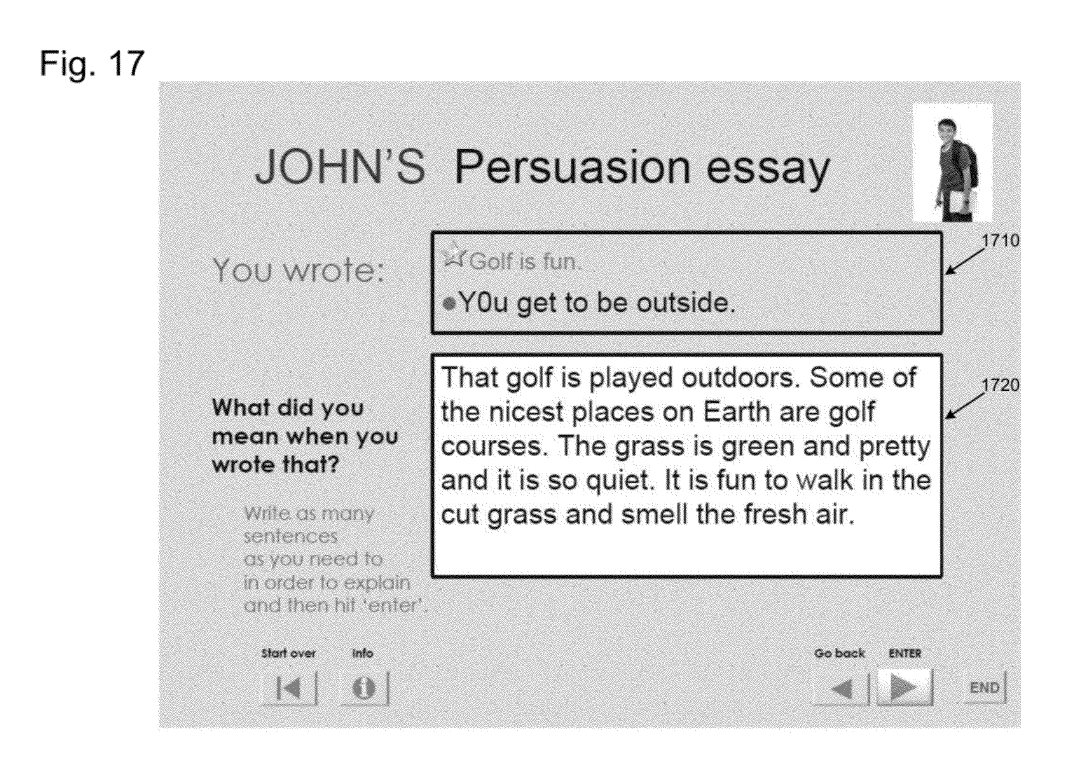

Next, the ICD 100 may prompt the student 150 to write additional sentences to buttress his or her first reason. For example, in the illustrated example of element 1710 of FIG. 17, the ICD 100 may present information to aid the student's progression but will lighten the font of the posted and starred thesis statement and darken the font of the first individual reason statement. This may serve to isolate importance as well as remind the student of the holistic objective. For example, the prompt may read: “You wrote: [first reason statement]. What did you mean when you wrote that?” In one implementation, the instructions may then ask the student to write as many sentences as are needed in order to explain what they meant by their first reason statement, such as in the response form of element 1720. In other implementations, the student may be limited to a pre-determined number of sentences, or may be asked to include a minimum number of sentences. Next, the ICD 100 may then take the response and save it in the database in the order they are given by the student. In one implementation, the reworded thesis will be maintained to be placed directly after the first reason statement in the cumulative work already organized.

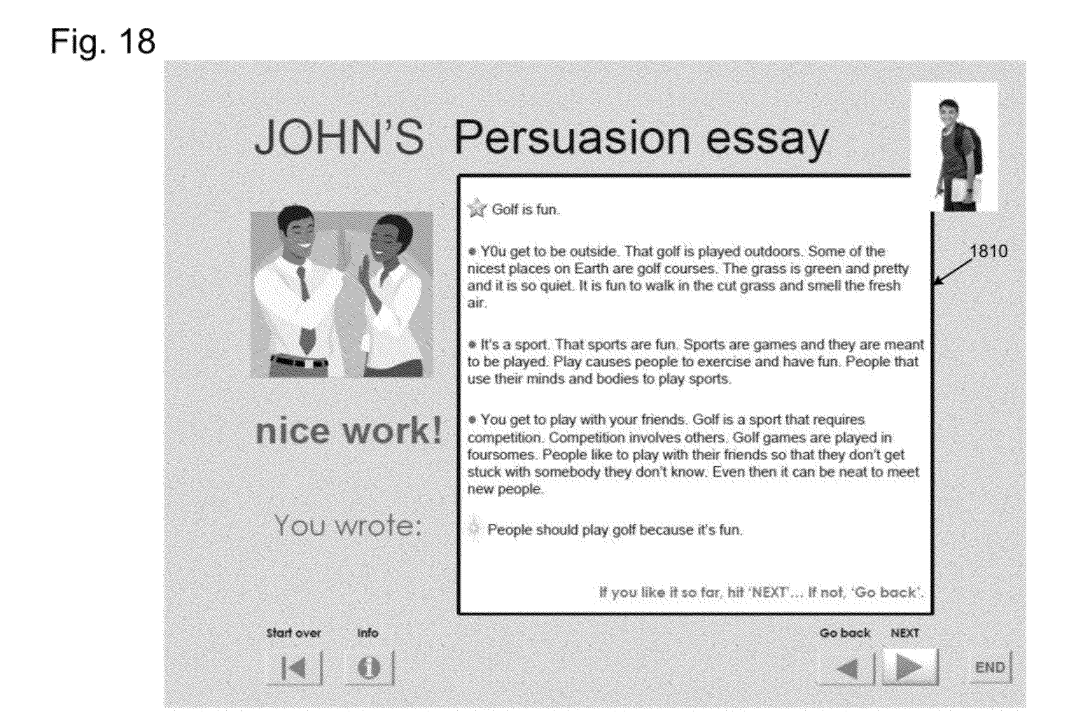

Next, in various implementations, and as illustrated as in FIG. 18, the ICD 100 may display cumulative work done so far according to the order provided by the ICD database 110, such as in element 1810. The ICD 100 may also offer the student the option of returning to previous pages to edit or save their work for later or to move onward. This process of prompting, eliciting one or more explanatory sentences for a previously-stated reason, and offering cumulative work for review may then be repeated for the second and third (or up to n) reasons which were previously provided by the student 150.

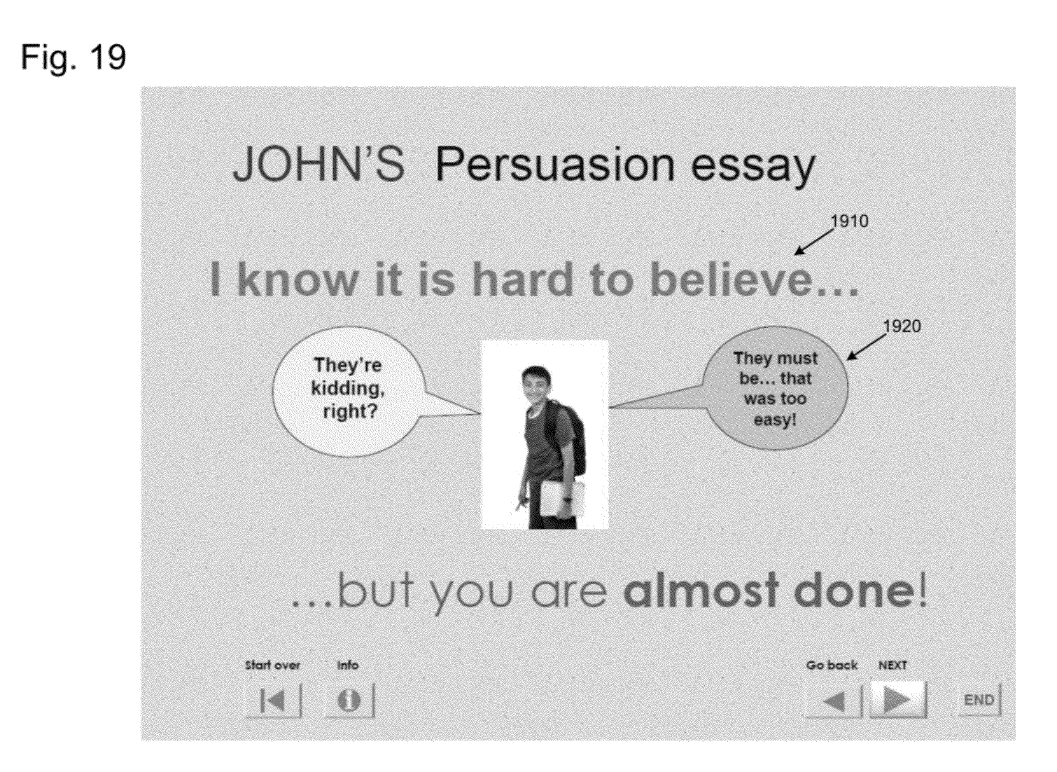

Next, the ICD 100 may provide one or more encouraging or motivational screen, such as the illustrated screen of FIG. 19, which, in the example, states “I know it is hard to believe . . . but you are almost done!” at element 1910, with a larger centralized picture of the student 150 with balloon-statements such as “They're kidding, right?” and “They must be . . . that was way too easy!” at element 1920 In various implementations, the statements shown to the student 150 may be based on his or her personalized preferences and/or may be taken from a pre-set list of statements maintained on the database or on other storage.

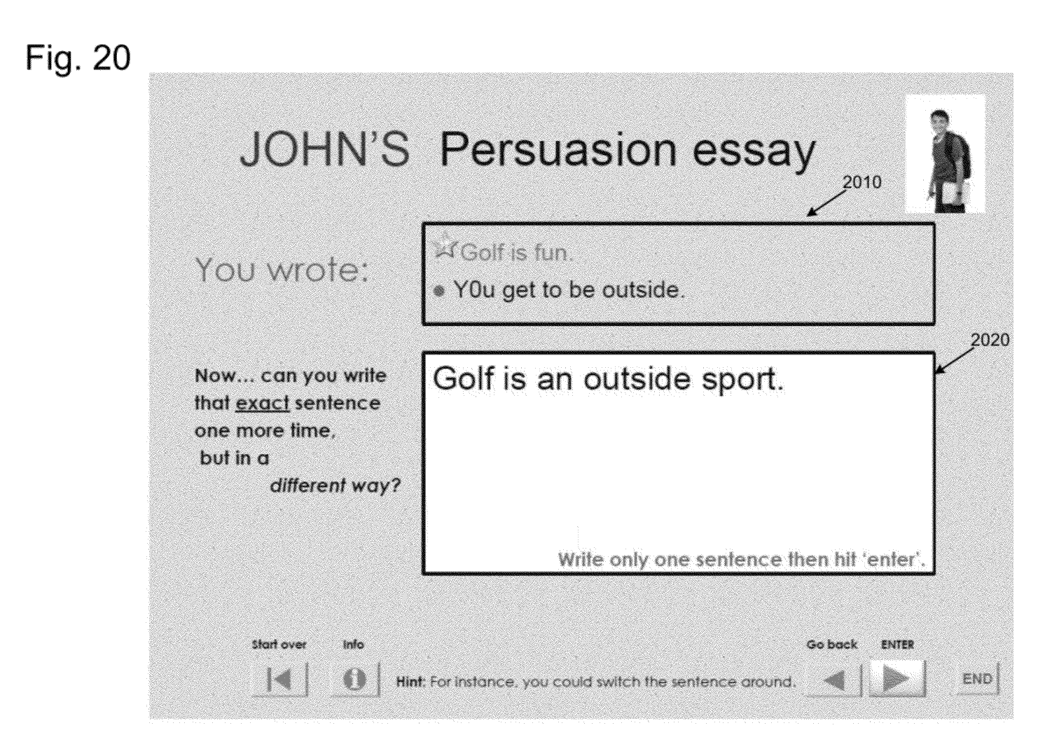

Next, the student may be offered the ability to re-state his or her previously-offered reasons, such as illustrated in FIG. 20. As illustrated, in various implementations, the screen offered to the student 150 will lighten the font of the thesis statement and will darken the font of the individual reason statement to isolate its importance as well as remind the student of the holistic objective, such as at element 2010. In the illustrated implementation of element 2010, the prompt reads: “You wrote: [first reason statement]. Now . . . can you write that exact sentence one more time, but in a different way?” In various implementations, the instructions may ask the student to write only one sentence, such as in the response form of element 2020. After receiving the student 150's response, the ICD 100 may take the statement and save it (such as in the database) as the first sentence of the introduction paragraph of the essay. The student's response may then be repeated as before in a cumulative work screen, and the process repeated for each of the reasons the student previously provided.

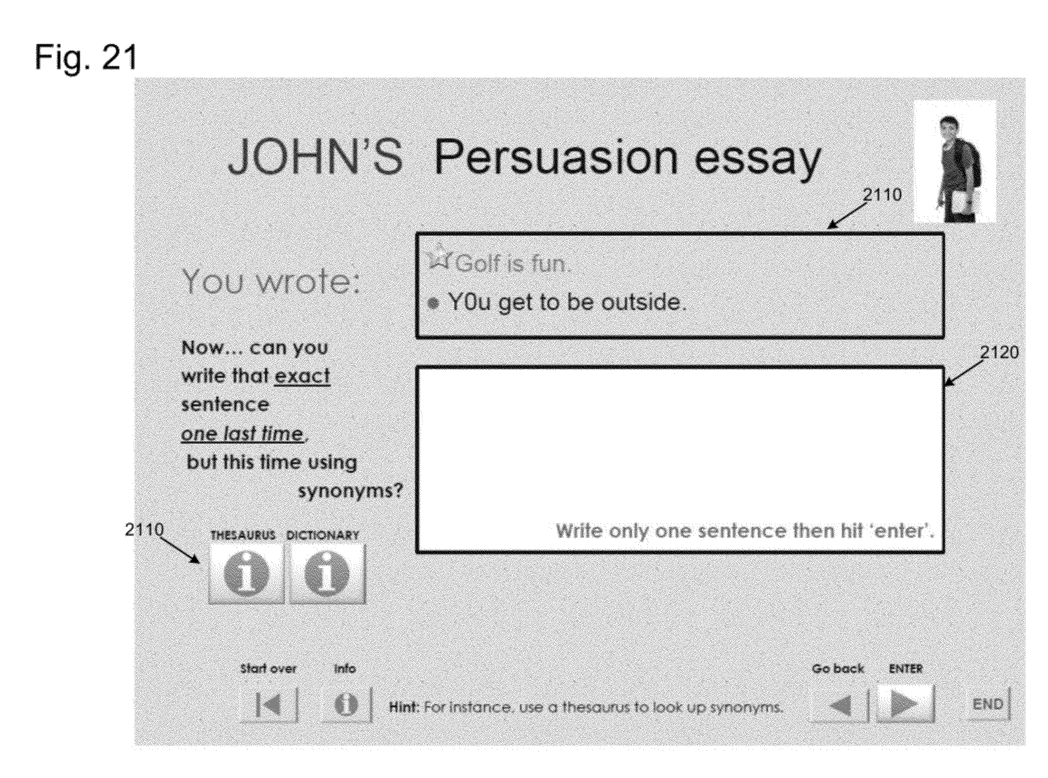

Next, the ICD 100 may once again prompt the student to repeat his reasons one more. As illustrated in the example of FIG. 21, the ICD 100 may provide ongoing access to an electronic dictionary and thesaurus, such as at element 2105, to aid the student his or her task of in repeating statements without changing their overall meaning. As before, the ICD 100 may lighten the font of the thesis statement and darken the font of the first individual reason statement to isolate importance as well as remind the student of the holistic objective, such as at element 2110. In one implementation, the prompt reads: “You wrote: [first reason statement]. Now . . . can you write that exact sentence one last time, but in a different way?” As above, in one implementation, the instructions may ask the student to write only one sentence, such as in the response form of element 2120. The ICD 100 may then save the statement, such as for example as the second sentence of the conclusion paragraph, just after the thesis reworded statement. The student's response may then be repeated as before in a cumulative work screen, and the process may be repeated, including access to the dictionary and thesaurus, for each of the reasons the student previously provided. Before the final prompt of this series, the ICD 100 may cue another encouraging or motivational screen, such as one stating “Here comes the FINAL QUESTION!” with a larger centralized picture of the student with balloon-statements such as “I'm almost done!” and “I'm so glad! I can't wait to see it finished!”

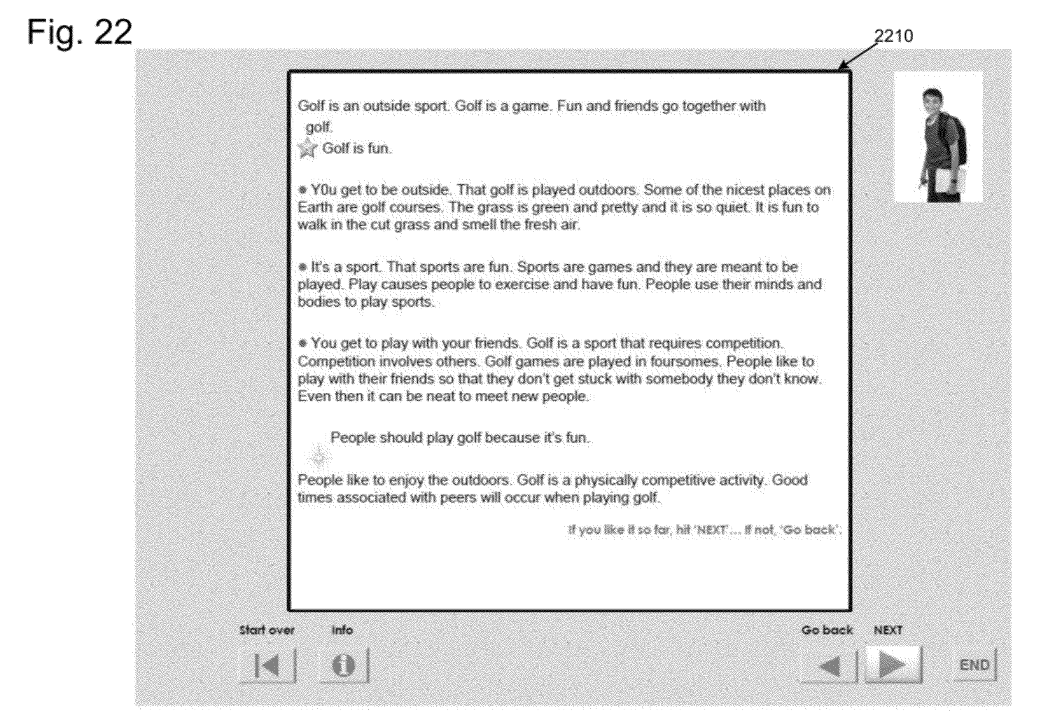

As illustrated in FIG. 22, the student may then be provided with a first final cumulative work page. In various implementations, this cumulative work page may be shown to the student in outline form, such as in element 2210. In various implementations, the work may be shown before additional lessons can be administered, such as grammar, punctuation, transitions, etc., but nonetheless may provide the basis of the core essay structure in the order maintained by the ICD database. The ICD 100 may also prompt the student 150, such as by asking: “Do you want to see it looking like a real essay now?”

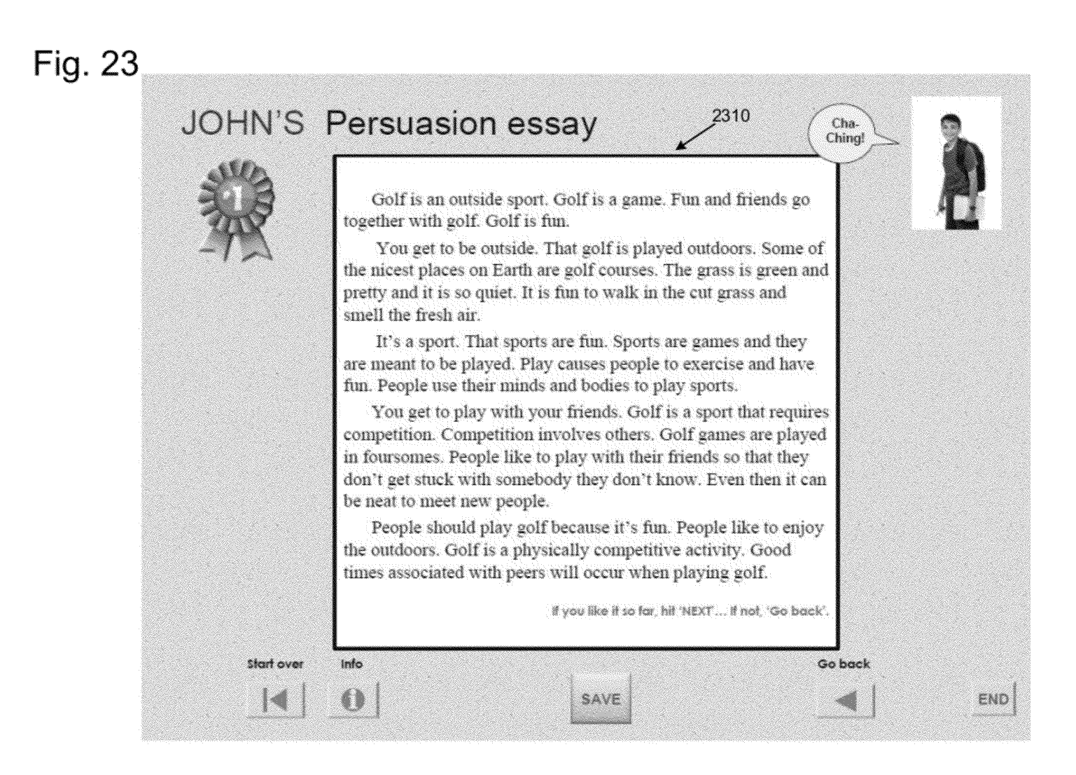

After receiving an indication that the student would like to proceed, the ICD 100 may then present a second final cumulative work page, such as illustrated in FIG. 23. This page may contain the same material as in the first final cumulative work page, but with finishing aspects such as a different font (e.g., Times New Roman), double-spacing, and/or traditional paragraph formatting in order to provide the student with a look of formality and encouragement by-proxy (as seen in the example of element 2310). The ICD 100 may then compliment the student 150 with a blue ribbon or other acknowledgement of the student 150's accomplishment and then prompt him or her to save his or her work.

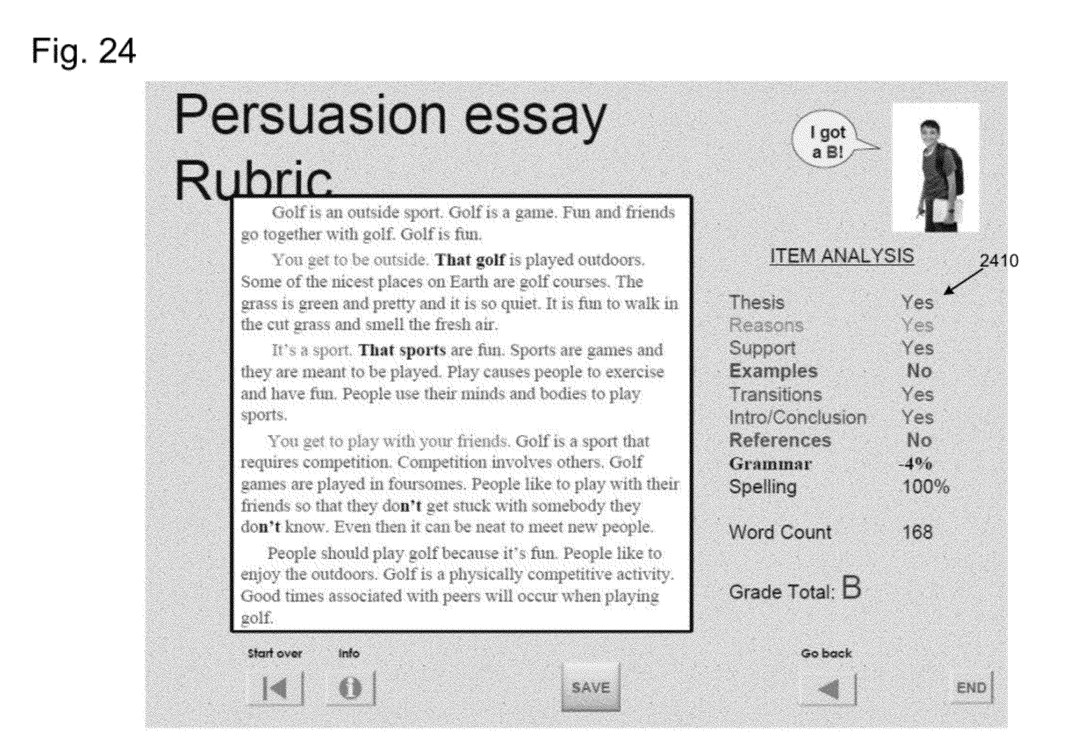

Next, the ICD 100 may check the student's work according to various forms of verification, such as, in the illustration of FIG. 24, thesis, reasons, support, examples, transitions, intro/conclusion statements, references, grammar, spelling, word count, and/or overall grade according to a loaded rubric. In various implementations, this may be performed automatically or the student may be prompted to request one or more verifications. In various implementations, various metrics may be generated from the work and displayed, as illustrated in element 2410. Additionally, the verifications which are performed and/or offered may be pre-set by an instructor or other administrator and the verification preferences stored in the database. In some implementations, school administrators may set standards for verifications which are not modifiable by the student and/or the teacher; this can provide a base level of standard of quality for the student work.

Next, the ICD 100 may prompt the student to choose from among various finished publishing capabilities based upon the ‘accepted/graded’ work thus far. In various implementations, the ICD 100 may present the student with options such as (but not limited to) essay hard-copy, cover page, prompts for references, presentation outline, electronic visual aid presentation, peer rubrics, and/or a teacher rubric. As before, the capabilities which are offered may be pre-set by an instructor or other administrator or based on the student 150's preferences, and these preferences stored in the database.

In various implementations, once the published items are prepared, the ICD 100 may prompt the student 150 with choices to create a new essay or speech or return to previous work. In various implementations, blogs or polls may also be given at this point as a system of rewards for completed work. These blogs or polls may also be kept, as above, under the control instructors or administrators according to pre-set options set or the availability of computers per student. In some implementations, the blogs and/or polls may be maintained on the ICD database outside of any personal computer on which the ICD 100 is being used. Thus, in some implementations, the ICD 100 may require additional “singing up” with a centralized blogging/polling entity or the purchase of additional licenses to perform these blogging and polling activities.

In various implementations (not illustrated) the student 150 may proceed to choose preparation of a speech. In various implementations, this drafting may use the same or similar prompts according to the category of the presentation. Also, in various implementations, subsequent prompting will be introduced to specific areas of need with respect to presentations, such as outline formatting, recording capabilities (e.g., computer cameras and computer voice recorders), practice of performances and memorization, as well as use of electronic visual aids (e.g., graphics, custom animation, slide transition, special effects, etc.).

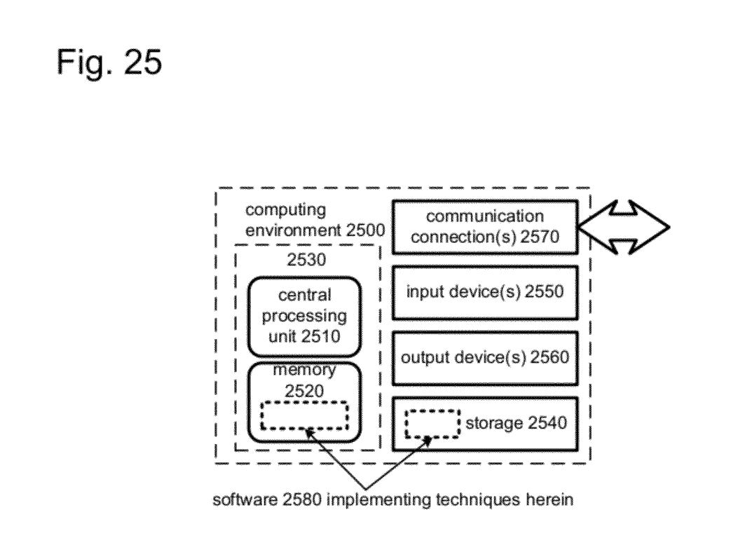

With reference to FIG. 25, the computing environment 2500 includes at least one CPU 2510 and associated memory 2520. In FIG. 1, this most basic configuration 2530 is included within a dashed line. The processing unit 2510 executes computer-executable instructions and may be a real or a virtual processor. In a multi-processing system, multiple processing units execute computer-executable instructions to increase processing power. In some implementations, these operations may be computationally intensive operations. In others, entire sub-processes of the general decoding process may be performed by particular hardware acceleration. The memory 2520 may be volatile memory (e.g., registers, cache, RAM), non-volatile memory (e.g., ROM, EEPROM, flash memory, etc.), or some combination of the two. The memory 2520 stores software 2580 implementing the techniques described herein.

A computing environment may have additional features. For example, the computing environment 2500 includes storage 2540, one or more input devices 2550, one or more output devices 2560, and one or more communication connections 2570. An interconnection mechanism (not shown) such as a bus, controller, or network interconnects the components of the computing environment 2500. Typically, operating system software (not shown) provides an operating environment for other software executing in the computing environment 2500, and coordinates activities of the components of the computing environment 2500.

The storage 2540 may be removable or non-removable, and includes magnetic disks, magnetic tapes or cassettes, CD-ROMs, DVDs, flash drives, disk arrays, or any other medium which can be used to store information and which can be accessed within the computing environment 2500. The storage 2540 stores instructions for the software.

The input device(s) 2550 may be a touch input device such as a keyboard, mouse, pen, or trackball, a voice input device, a scanning device, or another device that provides input to the computing environment 2500. For audio or video encoding, the input device(s) 2550 may be a sound card, video card, TV tuner card, or similar device that accepts audio or video input in analog or digital form, or a CD- or DVD-based drive that reads audio or video samples into the computing environment 2500. The output device(s) 2560 may be a display (e.g., monitor, display screen, or the like), printer, speaker, DVD-writer, or another device that provides output from the computing environment 2500.

The communication connection(s) 2570 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The techniques and tools can be described in the general context of computer-readable media. Computer-readable media are any available media that can be accessed within a computing environment. By way of example, and not limitation, with the computing environment 2500, computer-readable media include memory 2520, computer-readable storage media 2540 (e.g., CDs, DVDs, diskettes, flash drives, removable hard drives, hard drive arrays), and combinations of any of the above.

The techniques and tools can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description may use terms like “prompt,” “show,” and “return” to describe computer operations in a computing environment. These terms are high-level abstractions for operations performed by a computer, and should not be confused with acts performed by a human being. The actual computer operations corresponding to these terms vary depending on implementation.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended all matter contained in the above description shall be interpreted as illustrative and not in a limiting sense.

What is claimed is:

1. A computer-implemented method comprising:
displaying, by a computing device, one or more written response prompts to a user, the written response prompts configured to elicit written responses that will be included in a completed written communication;
recording, by the computing device, written responses elicited by the written response prompts;
generating, by the computing device, a piece of written communication based at least in part on the written responses;
displaying, by the computing device, the generated piece of written communication to the user.

2. The method of claim 1, wherein displaying the one or more written response prompts comprises displaying the one or more written response prompts such that they are visually enticing to a student.

3. The method of claim 1, wherein displaying the one or more written response prompts comprises displaying the one or more written response prompts such that they are contain minimal distractions.

4. The method of claim 1, wherein displaying the one or more written response prompts comprises displaying prompts that elicit written responses that are limited in length and/or scope.

5. The method of claim 1, further comprising:
presenting, by the computing device, one or more personal information prompts to the user;
recording, by the computing device, one or more pieces of user information provided in response to the personal information prompt; and
displaying to the user, by the computing device, selected pieces of user information out of one or more of the pieces of user information.

6. The method of claim 5, wherein displaying one or more of the pieces of user information comprises displaying the one or more pieces of user information concurrently with display of the one or more of the written response prompts.

7. The method of claim 1, wherein one or more of the written response prompts are based in part on one or more written responses that have previously been received from the user.

8. The method of claim 7, wherein one or more of the written response prompts request a restatement of a written response that has previously been received from the user.

9. The method of claim 8, further comprising presenting, by the computing device, one or more writing tools to aid the user in restating the written response for which a request for a restatement was made.

10. The method of claim 7, wherein one or more of the written response prompts request additional explanation of a written response that has previously been received from the user.

11. The method of claim 1, wherein generating the piece of written communication comprises generating the written communication in outline form.

12. The method of claim 1, wherein generating the piece of written communication comprises generating the written communication in essay form.

13. The method of claim 1, further comprising, generating, by the computing device, one or more written communication metrics based on the generated written communication.

14. The method of claim 1, further comprising:
requesting, by the computing device, that the user select a type or goal of the written communication;
selecting or generating one or more of the written response prompts based at least in part on the selected type or goal; and
wherein displaying the written response prompts comprises displaying the selected or generated written response prompts.

15. The method of claim 1, further comprising presenting, by the computing device, one or more motivational messages to the user, the motivational messages configured to encourage the user to continue to provide written responses.

16. The method of claim 1, wherein the piece of written communication is an essay.

17. The method of claim 1, further comprising storing, by the computing device, the written communication for later retrieval.

18. An apparatus comprising:
a computer processor;
an interactive display module configured to operate on the computer processor to:
select and/or generate one or more written response prompts for presentation to a user;
display the selected and/or generated written response prompts to a user, the written response prompts configured to elicit written responses that will be included in a completed essay;
receive one or more written responses elicited by the written response prompts;
generating the essay based at least in part on the written responses;
displaying the essay the user.

19. The apparatus of claim 18, further comprising:
a database configured to store one or more of the received written responses; and
a database interaction module configured to operate on the computer processor to record the received written responses in the database.

20. The apparatus of claim 18, wherein the interactive display module is configured to generate one or more written response prompts through generation of written response prompts that include a display of one or more previously-received written responses prompt for the user to provide a written response related to the displayed previously-received written responses.

21. One or more computer-readable storage media comprising instructions configured to cause a computing device, in response to execution of the instructions by the computing device, to:
select and/or generate one or more written response prompts for presentation to a user;
display the selected and/or generated written response prompts to a user, the written response prompts configured to elicit written responses that will be included in a completed essay;
record the received written responses in the database.
receive one or more written responses elicited by the written response prompts;
generating the essay based at least in part on the written responses;
displaying the essay the user.

22. The computer-readable media of claim 21, wherein the instructions are further configured to cause the computing device, in response to execution of the instructions, to generate written response prompts that include a display of one or more previously-received written responses prompt for the user to provide a written response related to the displayed previously-received written responses.

23. The computer-readable media of claim 21, wherein the instructions are further configured to cause the computing device, in response to execution of the instructions, to:
request that the user select a type or goal of the essay;
and select or generate one or more re of the written response prompts based at least in part on the selected type or goal.
